(19) United States
(12) Patent Application Publication
(10) Pub. No.: US 2006/0263572 A1
(43) Pub. Date: Nov. 23, 2006

(54) Decorative tiles for attachment to strand meshes

(76) Inventor: Christopher M. Edwards, Midland, MI (US)

Correspondence Address: GARY C. COHN, PLLC, 1147 NORTH FOURTH STREET, UNIT 6E, PHILADELPHIA, PA, 19123, US

(21) Appl. No.: 11/273,538

(22) Filed: Nov. 14, 2005

Related U.S. Application Data
(63) Continuation of application No. 10/607,920, filed on Jun. 27, 2003, now abandoned.

(51) Int. Cl. B32B 3/06

(52) U.S. Cl. 428/99

(57) ABSTRACT

Planar tiles have a specified design are used to cover openings in meshes such as chain link fences. The tiles can be arranged to form alphanumeric characters or other writings, various designs or other patterns. The tiles are made of a flexible, resilient material such as a polymer sheet material, or paper or cardboard that is coated with wax or a polymer layer. The tiles may be used to affix various attachments to the mesh, or to carry printed or other matter.

### CROSS-REFERENCE TO RELATED APPLICATION

This application is a continuation of application Ser. No. 10/607,920, filed Jun. 27, 2003.

### BACKGROUND OF THE INVENTION

This invention relates to signs, windscreens, decorative displays, and the like, that are made by adapting a mesh structure such as chain link fence.

Mesh fences, and chain link types in particular, are very common. As these fences consist of thin strands that define a large number of relatively large openings, these fences do not block either the wind or the view. It is often desirable that the fence be adapted to function as a windscreen or to provide privacy. Because many of these fences are visible to the public from roadways or other public fences, it is sometimes desirable to use them to carry advertising, informational or decorative materials. Various methods have been devised to adapt these fences to form windscreens, signs or displays by affixing things to or within the mesh. For example, U.S. Pat. Nos. 4,512,556 and 5,899,442 to Meglino describe slats that are inserted horizontally within the links of a chain link fence, effectively filling the openings and providing windbreaking and/or privacy. As described in U.S. Pat. No. 5,899,442, these slats have a complex cross-section and made of multiple materials, and as such are relatively expensive. Further, the slats do not permit one to easily make signs or complex shapes or symbols. The slats, once installed, cannot be rearranged easily to form a new pattern, design, symbols or message.

More complex designs and symbols can be formed if individual openings in the fence or mesh are separately covered. This general approach allows one to cover each individual opening with a covering having a predetermined color and/or texture (or to selectively cover only certain openings). Patterns, designs and symbols can be created through the placement of the coverings of the various colors or textures over individual openings in the fence. U.S. Pat. Nos. 3,964,197, 5,177,890 and 5,441,239 are all examples of this approach.

In U.S. Pat. No. 5,441,239, the individual coverings consist of two mating pieces that are snapped together over intersecting strands. This approach is expensive because two separate, three dimensional pieces must be formed to cover each opening, and labor intensive as the pieces must each be brought into position and snapped together. In U.S. Pat. No. 5,177,890, the individual coverings form rigid loops having an opening through which a horizontal fence strand is inserted. The coverings snap together after the strand is inserted to close the loop. This approach still requires relatively expensive covering pieces and is labor-intensive to install because the loops must be passed over the fence strands and then snapped closed. Because the loops are designed to hang over horizontal strands, this approach is not suitable for use in most chain link fences, where the strands are disposed at an angle to the horizontal.

In U.S. Pat. No. 3,964,197, openings in a chain link fence are filled with specially-shaped tiles that engage two of the strands that form each opening in the fence. Each engaging mechanism is a sequence of three tabs located along one end of the tile. The tabs are separated by cut-outs for receiving the strand. The center tab is bent downward slightly, so the strand fits under the first tab, over the second tab and under the third tab. The tiles are curved so that the strand is held tightly between the tabs. As before, the complex tile design increases the cost of the tiles quite substantially. The tabs protrude from the surface of the fence. As they must be somewhat rigid (sheet metal is taught as the preferred material) in order to hold their curved shape and to snap securely to the strands, the protruding tabs tend to have sharp edges which represent a safety hazard.

Accordingly, it would be desirable to provide an inexpensive and safe method for adapting strand meshes to form signs, windbreaks, privacy screens, decorative displays and the like.

### SUMMARY OF THE INVENTION

In one aspect, this invention is a flat tile of a flexible, resilient material having a body portion in the shape of a parallelogram and tabs extending outwardly from each of said sides, said body portion being adapted to substantially fill a parallelogram-shaped opening in a strand mesh, said opening being formed by two intersecting pairs of substantially parallel strands, and said tabs each being adapted to fit between one of said pairs of substantially parallel strands.

In a second aspect, this invention is a flat tile of a flexible, resilient material, said tile comprising a body portion having the shape of a rhombus of from 1 to 2⅜ inches on each side, and tab portions extending from about ¼ to ¾ inch from each side of the body portion.

In another aspect, this invention is a method of modifying a mesh having a plurality of openings each being formed by two intersecting pairs of substantially parallel strands, comprising inserting flat tiles of the first aspect of this invention into at least a portion of such openings, such that the body portions of the tiles substantially fill the opening and the tiles are held in place in the opening by engagement of said tab portions with the strands.

In yet another aspect, this invention is a mesh having a plurality of openings each being formed by two intersecting pairs of substantially parallel strands, where flat tiles are inserted into at least a portion of such opening in a predetermined pattern, wherein the flat tiles have a body portion in the shape of a parallelogram and tabs extending outwardly from each of said sides, said body portion being adapted to substantially fill said opening, and said tabs each being adapted to fit between one of said pairs of substantially parallel strands and hold the tile in the opening through engagement with at least some of strands that form the opening.

### BRIEF DESCRIPTION OF THE DRAWINGS

FIG. 1 is a front view of chain link fence having a tile of the invention inserted over on of its openings.

FIG. 1A is an enlarged side view of a tile of the invention inserted into an opening of a chain link fence.

FIGS. 2, 3 and 4 are front views of embodiments of the tile of the invention.

FIG. 5 is a rear view of a chain link fence having a design piece fastened to it via a tile of the invention. FIG. 5A is an enlarged side view of a section of a chain link fence having a design piece fastened to it via a tile of the invention.

FIG. 6 is an isometric view illustrating a method of inserting a tile of the invention into a chain link fence.

### DETAILED DESCRIPTION OF THE INVENTION

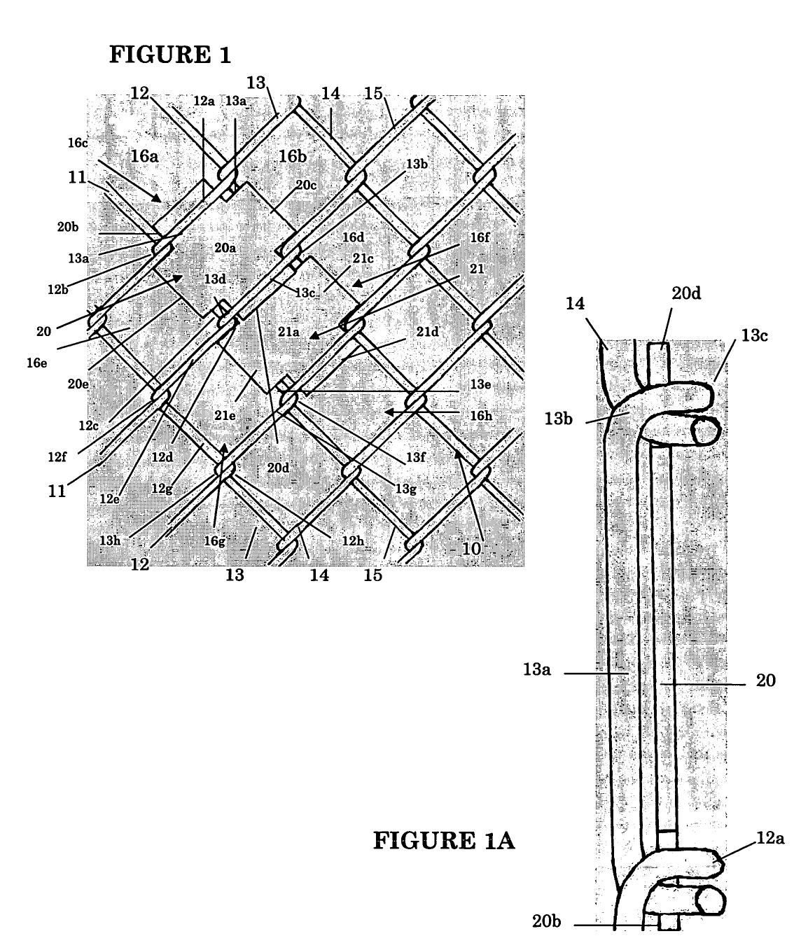

FIG. 1 illustrates a chain link fencing type of strand mesh that is useful in the invention. Mesh 10 includes a plurality of openings 16a-16h, each of which is bounded by two intersecting pairs of substantially parallel strands. Opening 16dc (in which tile 20 is inserted), for example, is defined by strands 12a, 13a, 12c and 13c, of which strands 12a and 13c form one substantially parallel pair and strands 13a and 12c form the second substantially parallel pair. In the embodiment shown, adjacent strands are oriented at approximately 90° to each other, and all strands are substantially the same length, so that openings 16a-16h are rough squares, oriented approximately 45° from the horizontal. The openings in the strand mesh are more generally described as parallelograms, i.e., closed quadrilaterals having two pairs of parallel sides. If the angles in the parallelogram are right angles (as shown), the openings are rectangular. If the sides are of equal length (as shown), the openings are rhombi. A rhombic opening in which the angles are right angles (as shown) forms a square opening. In the context of this invention, a “parallelogram” opening includes rectangular, rhombic and square openings. A “rectangular” opening and a “rhombic” opening each includes a square opening.

The tile of the invention consists of a body portion in the approximate shape of a parallelogram. The body portion is adapted (i.e., sized and shaped) to substantially fill a parallelogram-shaped opening in the strand mesh. The area of the body portion is preferably at least 75%, more preferably at least 90%, even more preferably at least 95% of the area of the opening in the strand mesh.

Along each side of the body are tabs that extend outwardly from the body portion. Those tabs extend outwardly enough to extend past the strands defining the opening in the strand mesh. The width of the tabs is such that they each fit between one of the pairs of parallel strands that define the opening in the strand mesh.

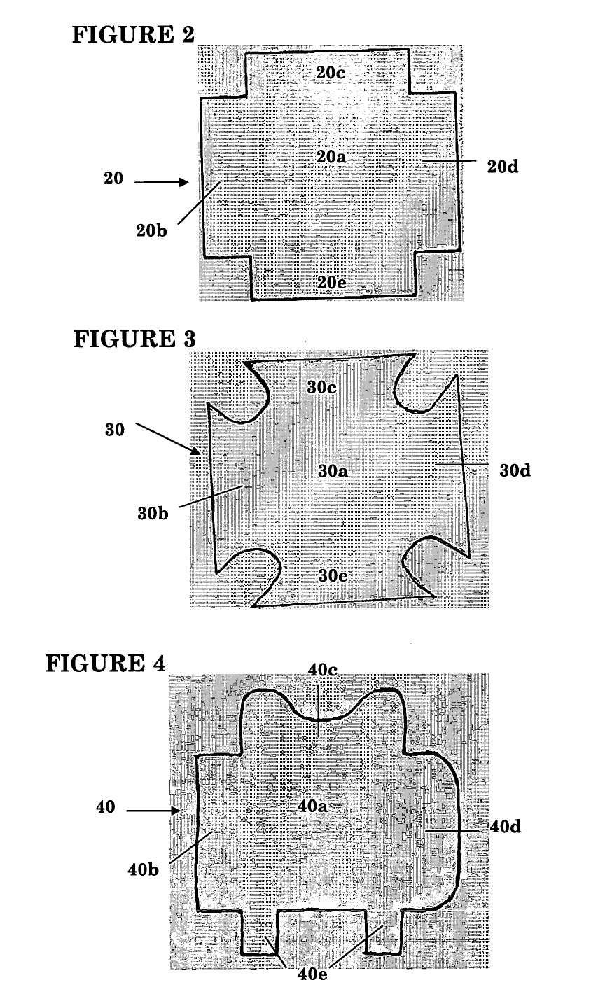

FIGS. 1 and 2 illustrate a tile of the invention and how its dimensions relate to the configuration of the strand mesh. In FIG. 2, an embodiment of tile 20 is shown with body portion 20a and tab portions 20b, 20c, 20d and 20e attached to each side of body 20a. Body 20a is in the shape of a parallogram (in this case, a square). As seen in FIG. 1, body 20a substantially fills opening 16c of mesh 10. Tabs 20b, 20c, 20d and 20e extend outwardly from body 20a. As shown, tab 20b has a width b and a length f, tab 20c has a width c and a length g, tab 20d has a width d and a length h and tab 20e has a width e and length i. The widths of tabs 20b, 20c, 20d and 20e are such that they fit between the respective pairs of parallel strands that form the mesh. Thus, in FIG. 1, the width of tabs 20b and 20d are each less than the spacing between strands 13a and 12c, and the width of tabs 20c and 20e are each less than the spacing between strands 12a and 13c.

The length of the tabs is such that when the tile is in place in the opening, the tabs extend over the respective strands forming the boundary of the opening and engage with the strands to hold the tile in place, by engaging with perpendicularly opposing pairs of strands. As shown in FIG. 1, tab 20b extends past strand 12a, tab 20c extends past strand 13a, tab 20d extends past strand 13c and tab 20e extends past strand 12c. One set of opposing tabs fits under the corresponding set of parallel strands, and the other set of opposing tabs fits over the other set of parallel strands. In FIG. 1, opposing tabs 20b and 20d fit under strands 12a and 13c, respectively, and opposing tabs 20c and 20e fit over strands 13a and 12c, respectively.

The mesh configuration shown in FIG. 1 is typical of most chain link fence constructions (also known as a mesh fence or a cyclone fence). The fence is comprised of a plurality of strands such as those shown at 11, 12, 13, 14 and 15 in FIG. 1, which contain regular bends at points where they intersect with adjacent strands. Thus, strand 12 includes a section 12a, a bend 12b which is linked to a similar bend in strand 11, a second section 12c, a second bend 12d which is linked to bend 13d in strand 13, another section 12e, a third bend 12f which is again linked to a similar bend in strand 11, and a section 12g followed by bend 12h which is linked again to bend 13h of strand 13. Strand 13 similarly contains a series of sections 13a, 13c, 13e and 13g connected by bends 13b, 13d, 13f and 13h, at which points it is linked either to strand 12 (at bends 13d and 13h) or strand 14 (at bends 13b and 13f).

The mesh configuration shown in FIG. 1 has several notable features. The straight sections of the various strands (such as 12a, 12c, 12e, 12g, 13a, 13c, 13e and 13g) are all approximately equal in length, so that the corresponding openings 16a-16h are rhombic. This is typical of standard chain link fence construction but is by no means necessary to the invention. The angles between adjacent sections of strand are all approximately 90° (i.e., the bends in the strands such as bends 12b, 12d, 12f, 12h, 13b, 13d, 13f and 13h are all approximately 90°) so that the openings 16a-16h are rectangular. Again, this is typical of standard chain link fence construction but not necessary. The combination of these features produces square openings 16a-16h. Accordingly, the body of tile 20 is preferably square to substantially match the size and shape of openings 16a-16h. In cases where the openings are not square, the shape of the body of the tile is adapted accordingly.

The most common mesh sizes for chain link fences in the North American market are squares with sides of 1¾, 2, 2⅛, 2¼ or 2⅜ inches. Mesh size is calculated from strand inner edge to opposing strand inner edge—i.e., the inside dimensions of the mesh. A tile as shown in FIG. 2, with a body width of 1.5 inches to 1.7 inches and tab lengths of 0.5 inch to 0.75 inch, is suitable for use with any of those standard square mesh sides.

Tabs 20b , c, d and e may each be narrower than the sides of body 20a, if desired. They may also have irregular or curved exterior edges if desired. Examples of such tabs are shown in FIGS. 3 and 4. In FIG. 3, tile 30 has body 30a and tabs 30b, 30c, 30d and 30e. Each of tabs 30b, 30c, 30d and 30e become wider with increasing distance from body 30a, and allow the tabs to hook around the corresponding strands of the mesh to better secure the tile. In FIG. 4, tile 40 has body 40a and tabs 40b, 40c, 40d and 40e. Tab 40b corresponds to those shown in FIGS. 1 and 2. Tabs 40c, 40d and 40e illustrate various alternative tab shapes, and further illustrate the concept that tabs on a single tile do not necessarily have the same shape.

The mesh configuration shown in FIG. 1 includes another preferred feature that is again typical of standard chain link fence construction. Each bend is a complex bend that includes a bend within the plane defined by the mesh, and a bend roughly perpendicular to that plane. For example, after section 12a, strand 12 is bent to the right approximately 90°, and is also bent somewhat downward (i.e., away from the viewer, as depicted). The next bend in the strand turns 90° to the left, and also somewhat upwardly. The bends in the strand thus alternate between left- and right-hand bends and also between upward and downward bends. The result of this construction is that the strands defining the mesh openings tend to reside in two separate planes, with strands running in one direction being in one plane, and strands running in the perpendicular direction being in the second plane. In FIG. 1, strands running downward and to the right (such as 13a, 12c, 13e and 12g) reside in a plane which is farther away from the viewer (by about the thickness of the strands) than the plane in which the strands running downward and to the left (such as 12a, 13c, 13c and 13g) reside. In this construction, each opening, such as opening 16d, is bounded by a first pair of parallel strands (12a and 13c) which reside in a different plane that the other two parallel strands (13a and 12c). This construction allows tile 20 to be inserted so that tabs 20b and 20d fit below (as shown) strands 12a and 13c, respectively and tabs 20c and 20e fit above strands 13a and 12c, respectively. This, in turn, allows tile 20 to fit flat or nearly flat within the general plane defined by mesh 10. The edges of the tile therefore do not protrude from the mesh and do not create a significant safety hazard. They are not easily damaged or removed by an object brushing the face of the mesh.

FIG. 1A further illustrates how the inserted tile fits within the mesh structure. In FIG. 1A, tile 20 is shown inserted between strand segments 13a, 13c (which as depicted points away from the viewer and to the right of tab 20d), 12a (which points away from the view and to the right of tab 20b) and a fourth strand segments (corresponding to 12c in FIG. 1) which is not shown but also runs to the left of tile 20 as depicted). Bend 13b interconnects with strand 14.

When adjacent openings are filled with tiles, as shown in FIG. 1, tabs of adjacent tiles overlap and do not extend out of the surface of the mesh. In FIG. 1, mesh 10 has tiles 20 and 21 inserted into adjacent openings 16c and 16f. Tile 20 has tab 20c that extends over strand 13a, tab 20b that extends under strand 12a, tab 20d that extends under strand 13c and tab 20e extending over strand 12c. Tile 21 has body 20a and four tabs (21c, 21d, 21e and a fourth tab that is eclipsed in this view by tab 20d of tile 20) extending over or under the peripheral strands that define opening 16f.

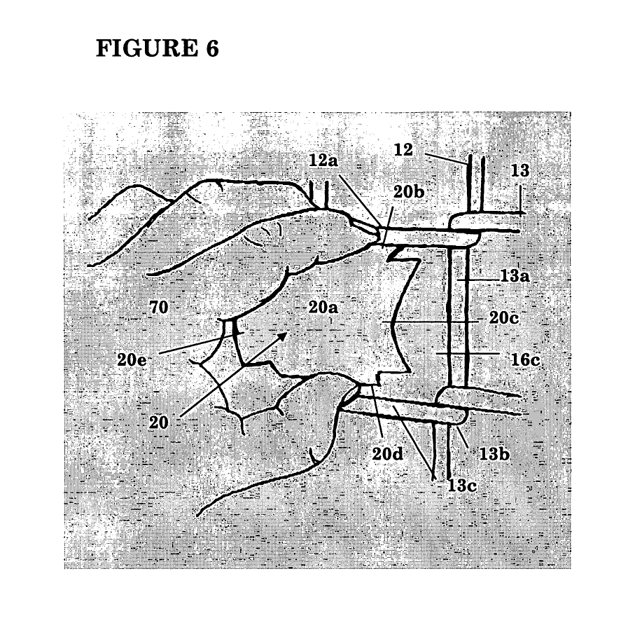

FIG. 6 illustrates the method of inserting tiles into the mesh. Tile 20 having body 20a and tabs 20b, 20c, 20d and 20e is bent so that tabs 20b and 20d are pointed toward the strand mesh. Tabs 20b and 20d are inserted beneath strands 12a and 13c, respectively, and the tile is released. The resiliency of the tile causes it to assume its original planar configuration, with tabs 20c and 20e resting above strand 12a and a parallel strand that is eclipsed in this view, and tabs 20b and 20d residing below strands 12a and 13c, respectively.

It should be noted that although the mesh described is a metal mesh used in chain link fence, the uses of this invention are not limited to chain link fence. Other kinds of mesh for which it can be used include welded strand mesh of the kind used to reinforce concrete, but also often used as temporary fencing around construction sites. The invention may also be used in mesh structures created as part of other artifacts, including for example, shopping carts and baskets, supermarket shelves, playpens and the like. In all these cases, the principal of operation would remain, but the size and configuration of the tile would be modified to suit the mesh. The invention may also be used for mesh where the parallel strands are of material other than metal, including plastic meshes (of various kinds) including those used in ski areas or gardens or to surround temporary construction work. Equally, it can be used in string or rope mesh. Further, the tile design may be easily adapted for meshes of other shapes such as hexagonal.

It should also be understood that although the drawings and representations of most kinds of mesh appear geometrically precise, in reality there are many minor variations caused by differences in tension in the mesh, localized damage, paint, or even corrosion. It is a further advantage of this invention that the flexibility and resiliency of the tiles used in this invention allow them to accommodate such variations.

The tiles of the invention are made from any flexible and resilient material. For purposes of this invention, a material is “flexible and resilient” if it can be deformed sufficiently to be inserted within the opening of a strand mesh and yet regains its original shape after insertion (except to the extent constrained by the strand mesh itself). The tile is preferably deformable under finger pressure. Suitable materials of construction include thermoplastic or thermosetting polymers of various types, paper, cardboard, metal, corrugated cardboard, or virtually any other type of flexible sheet material. Polymer sheet materials such as vinyl (PVC), polypropylene and polyethylene sheet are generally preferred, as they have particularly suitable physical properties and are or can be made resistant to exposure to moisture, humidity and sunlight. Paper or cardboard which has been treated to enhance its resistance to water for example, by coating with wax or polymer layers is also very suitable. The thickness of the tiles is sufficient to give the requisite flexibility and resiliency, and optimal thicknesses will vary with the particular material of construction. In general, tiles 0.005 to 0.075 inches in thickness are suitable, with thickness of 0.01 to 0.06 being preferred.

The tiles can be made simply and inexpensively by stamping them from a flat sheet material. The body portion and tabs are typically stamped simultaneously from a single piece of starting material. Because the tiles are flat, they stack easily, reducing transportation costs and making handling easier.

The tiles may be colored, either by incorporating the coloring into the material of construction or by applying colors or patterns to the surface of the tile (or starting sheet material). The tile may have a reflective, phosphorescent or luminescent surface if desired. The tiles may also be transparent. The tiles can be designed so that either or both faces are show surfaces. In the former case, the tiles will usually appear the same when viewed from either side, although the pattern made up by the tiles will be reversed. The opposing faces of the tiles may be the same or different. The tiles may be arranged into patterns, designs and/or symbols (such as numbers or lettering) through appropriate positioning of tiles of various colors in selected opening in the mesh, or by inserting tiles only in selected openings in the mesh.

A strand mesh having tiles of the invention in its openings can be used as privacy screens, windbreaks, noise barriers, sun shades, signs, advertising media, message board, art displays and the like.

The tiles may also function as labels or tags when affixed to openings in a strand mesh. In such cases, the tiles are typically printed or carry labels which contain, for example, instructions, product information, product identification, safety information, delivery information or other data.

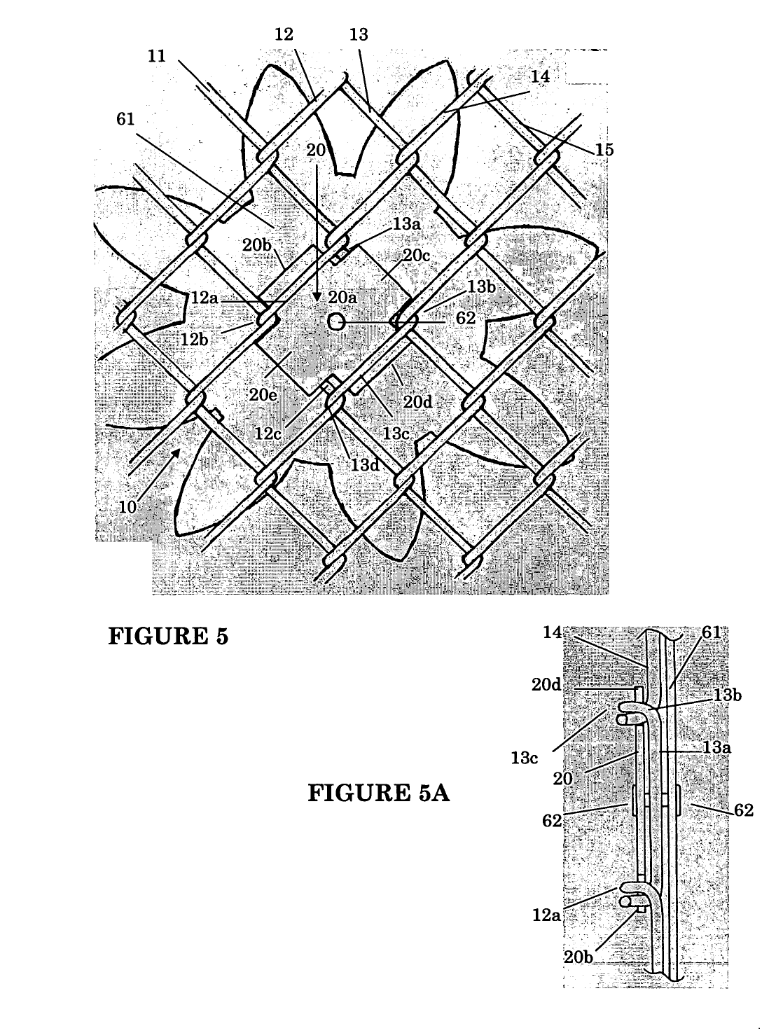

The tiles may also function as fasteners, by which other objects may be affixed to the strand mesh. The object is affixed to one or more tiles by any suitable means, and the tile(s) inserted into openings in the mesh as described above. Of particular interest are larger and/or more complex design elements which may be desirable in a particular case. However, any object can be affixed to a strand mesh in this manner, to the extent that the tiles can support the object's weight. This is illustrated in FIGS. 5 and 5A. In FIG. 5, design piece 61 (in the shape of a flower) is affixed to mesh 10 via tile 20. Mesh 10 is made up of strands such as 11, 12, 13, 14 and 15, which are interwoven in the manner described with respect to FIG. 1. As before, tile 20 includes body portion 20e and tabs 20b, 20c, 20d and 20e. Tile 20 is affixed to design piece 61 via rivet 62. Strand 12 includes segment 12a, bend 12b and segment 12c, whereas strand 13 includes segment 13a, bend 13b, segment 13c and bend 13d. Tab 20b is inserted behind segment 12a, tab 20d is inserted behind segment 13c, tab 20c is inserted in front of segment 13a and tab 20e is inserted in front of segment 12c. The tile can of course be affixed to the design piece by any suitable means. It is sometimes preferred that the tile be rotatably affixed to the design piece (or other attachment) so that the tile can be manipulated easily for insertion into the mesh. Of course, multiple tiles can be used to affix an attachment to the mesh.

FIG. 5A illustrates how the tile and affixed design piece fit within the mesh. In FIG. 5A, tile 20 is shown inserted between strand segments 13a, 13c (which as depicted points away from the viewer and to the left of tab 20d), 12a (which points away from the view and to the left of tab 20b) and a fourth strand segment (corresponding to 12c in FIG. 1) which is not shown but also runs to the right of tile 20 as depicted). Bend 13b interconnects with strand 14. Rivet 62 connects tile 20 to tile 61.

Having described the invention generally, it will be recognized that various modifications can be made thereto without departing from the scope thereof as limited only by the appended claims.

1. A flat tile of a flexible, resilient material having a body portion in the shape of a parallelogram and tabs extending outwardly from each of said sides, said body portion being adapted to substantially fill a parallelogram-shaped opening in a strand mesh, said opening being formed by two intersecting pairs of substantially parallel strands, said tabs each being adapted to fit between one of said pairs of substantially parallel strands, said body having a length of from 1 to 2⅜ inches on each side and said tab portions extending from about ¼ to ¾% from each side of the body portion.

2. The flat tile of claim 1 which is deformable under finger pressure.

3. The flat tile of claim 2, wherein the flexible, resilient material is a polymer sheet material, or paper or cardboard that is coated with wax or a polymer layer.

4. The flat tile of claim 3, wherein said opening is roughly in the shape of a rough square, and the body of said tile is roughly in the shape of a square.

5. The flat tile of claim 3, wherein the body is roughly in the shape of a square from about 1.5-1.7 inches on a side, and said tabs each extend outwardly from said body from about 0.5 to about 0.75 inch.

6-7. (canceled)

8. The flat tile of claim ; 1 which is formed of a polymer sheet material of 0.005 to 0.075 inches in thickness.

9. A method of modifying a strand mesh having a plurality of openings each being formed by two intersecting pairs of substantially parallel strands, comprising inserting flat tiles of claim 1 into at least a portion of the openings, such that the body portions of the tiles substantially fill the openings and the tiles are held in place in the opening by engagement of said tab portions with the strands.

10. The method of claim 9 wherein the mesh is a chain link fence.

11. The method of claim 10 wherein said openings are roughly square, and said body portion of the tiles are roughly square in shape.

12. The method of claim 11 wherein said tiles are made from a flexible, resilient material.

13. The method of claim 12, wherein a plurality of tiles are are arranged in openings in the strand mesh to form a pattern, design or symbol.

14. A strand mesh having a plurality of openings each being formed by two intersecting pairs of substantially parallel strands, where flat tiles are inserted into at least a portion of the opening in a predetermined pattern, wherein the flat tiles have a body portion in the shape of a parallelogram and tabs extending outwardly from each of said sides, said body portion being adapted to substantially fill said opening, and said tabs each being adapted to fit between one of said pairs of substantially parallel strands and hold the tile in the opening through engagement with at least some of the strands that form the openings further wherein said body having a length of from 1 to 2⅜ inches on each side, and said tab portions extending from about e,fra 1/4to ¾% inch from each side of the body portion.

15. The strand mesh of claim 14 wherein the flat tiles are arranged in a pattern, design or symbol.

16. The strand mesh of claim 14 wherein an object is attached to the strand mesh by at least one tile.
